(19) United States
(12) Patent Application Publication
(10) Pub. No.: US 2008/0141301 A1
(43) Pub. Date: Jun. 12, 2008

(54) METHODS AND SYSTEMS FOR DELIVERING PERSONALIZED HEALTH RELATED MESSAGES AND ADVERTISEMENTS

(75) Inventors: STEVEN HECTOR AZZARO, SCHENECTADY, NY (US); VIRGINIA ANN ZINGELEWICZ, SCOTIA, NY (US); CHRISTOPHER DONALD JOHNSON, CLIFTON PARK, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/608,464

(22) Filed: Dec. 8, 2006

(51) Int. Cl. G06F 3/00

(52) U.S. Cl. 725/34

(57) ABSTRACT

Systems and methods, for delivering targeted content to specific individuals, that provide health related information about an individual; correlates the individual with the targeted content based at least in part on the health related information; and delivers the targeted content to the individual through a device for delivering media content.

### BACKGROUND

The invention relates generally to methods and systems for delivering personalized health related messages and advertisements.

Targeted advertising to date has been based on consumer demographics and buying histories. These campaigns are scheduled and distributed regardless of who specifically is receiving content and their unique health. Despite the growing number of older adults and improvements in healthcare, efforts have not been made to incorporate personalized advertising and commercial content into the health care related domain, based upon specific disease or biometrical state.

### BRIEF DESCRIPTION

The methods and systems tie automated health assessment technology with the ability to deliver messages via media channels that closely match the viewer's disease and state of health wellness.

The expected increases in elder care and health care costs will be a significant factor in everyone's budgets over the next couple of decades. Education and reinforcement of positive behaviors are common, recurring themes in a total solution to these growing problems. Harnessing the power of the media will be a key ingredient to having an impact in this area. Where information from a monitoring system or other sources is available, the methods and systems enable companies that provide medical products and services, such as pharmaceutical companies, to advertise through targeted advertising. The right patients will see more precisely targeted pharmaceutical advertisements that have the highest probability of being relevant to the viewer's condition, protocol and state of wellness. This may be especially advantageous because the response and/or prescribing effectiveness of such advertisements has dropped significantly in the past few years. The commercial content will be more informative. For example, the information may provide instructions about side effects specific to a viewer's protocol archetype, why the prescription or its use is important to drive compliance, and other pertinent information such as feedback of biometrical state of wellness and dose to protocol.

Rising costs and increasing incidence will require patients with chronic disease to take a bigger role in assuring they remain as healthy as possible for as long as possible. These methods and systems are adapted to use media advertising channels as a means to educate consumers about their conditions and medications through advertising and targeted messages that are based on their current health condition.

An embodiment of the methods for delivering targeted content to specific individuals generally comprises the steps of, providing health related information about an individual; correlating the individual with the targeted content based, at least in part, on the health related information or protocol; delivering the targeted content to the individual through a means for delivering media content. The means for delivering media content may comprise: a television comprising one or more closed captioning options; a television and a set top box, that is in communication with the television, adapted to receive signals from an external source; and/or a processor that is adapted to receive digital information from an external source corresponding to the targeted content and a digital display device for displaying the targeted content. The means for delivering media content may further comprise a display screen adapted to display the targeted content on the screen while simultaneously displaying one or more unrelated images. The method may further comprise the steps of monitoring the activity of the individual in a living area of the individual and generating at least part of the health related information based on the activity of the individual.

The targeted content may comprise, but is not limited to, one or more advertisements for products or services; and/or one or more instructions to take one or more specific actions. The actions may be health related and more specifically may be selected from a group of actions consisting of: taking one or more medications, changing or continuing a lifestyle activity (e.g., relating to diet or exercise), contacting a health care provider, and turning a health related device on or off.

An embodiment of the system for delivering targeted content to specific individuals based at least in part on health related information about an individual generally comprises: a communications network that is adapted to deliver the targeted content to the individual through a device for delivering media content. The device for delivering media content may generally comprise a television provided with one or more closed captioning options; is a television and a set top box, that is in communication with the television, adapted to receive signals from an external source; is a processor that is adapted to receive digital information from an external source corresponding to the targeted content and a digital display device for displaying the targeted content. The device for delivering media content may similarly comprise a display screen adapted to display the targeted content on the screen while simultaneously displaying one or more unrelated images. The display device and related hardware may or may not be interactive.

The network may comprise a cable network; a satellite based network; and/or a computer-based network. The system may further comprise an activity monitoring system for monitoring the activity of the individual in a living area of the individual and generating at least part of the health related information based on the activity of the individual.

As with the method, the targeted content may comprise, but is not limited to, one or more advertisements for products or services; and/or one or more instructions to take one or more specific actions. Such actions may be, but are not limited to, a group of actions consisting of: taking one or more medications, contacting a health care provider, and turning a device on or off.

These methods and systems tie automated health assessment technology with the ability to deliver high impact messages via existing media channels. High impact refers to messaging that increases the probability of a desired decision or action. Such high impact messages could be used as a type of media-based prescription that may be prescribed by medical professionals to help patients understand and cope with their illnesses through targeted education. They enable more effective solutions for chronic disease by enabling a patient to remain out of the hospital longer with improved quality of life. The feedback and education provided will not require additional patient effort but will be delivered through media events and advertising similar to what they are currently watching on TV, PDA, Podcast or experiencing on the web.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of the system for delivering targeted content; and

FIG. 2 is a block diagram of an embodiment of the health monitoring system for obtaining health related information about an individual for use in the system for delivering targeted content of FIG. 1.

### DETAILED DESCRIPTION

The systems and methods enable individual patients to receive information that is targeted to their particular diseases and states of health. Individuals may be watching the same show in their respective homes, but advertisement blocks deliver targeted information to specific individuals based on the various individual's needs and current biometrical conditions. Conditions, protocols and needs are specific to patients.

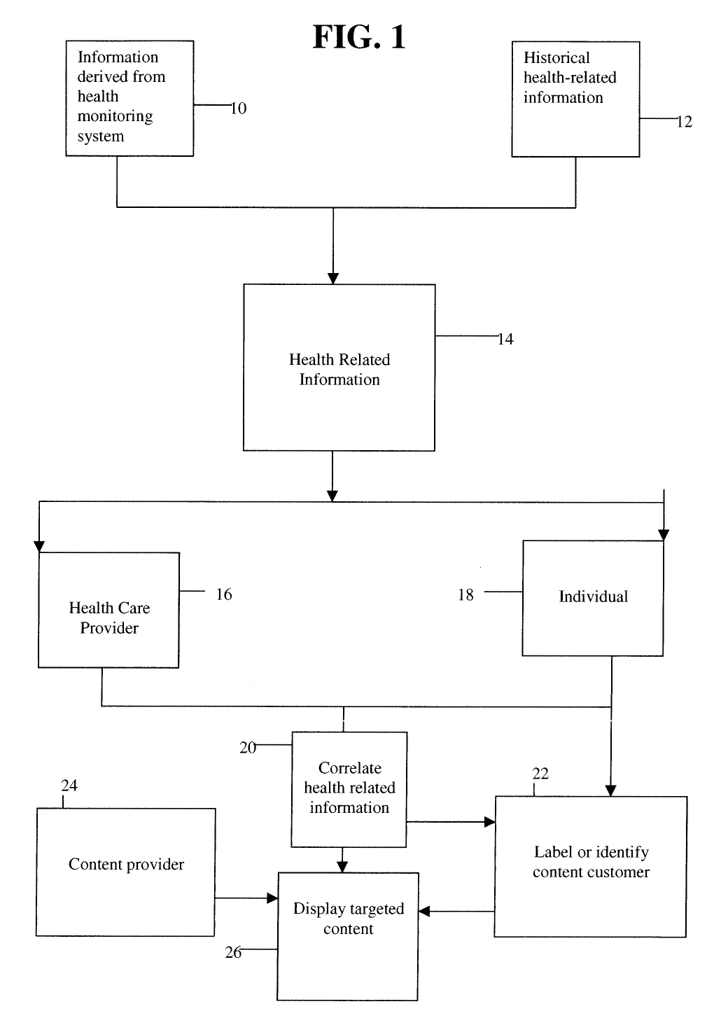

One embodiment of the method, as shown in FIG. 1, for delivering targeted content to specific individuals generally comprises the steps of providing health related information 14 about an individual; correlating, in step 20, the individual with the targeted content based at least in part on the individual's health related information; and delivering, via steps 22, 24 and/or 26, the targeted content to the individual through a means for delivering media content. The information may be correlated using a logical tree such as a protocol to assess either manually or automatically, what should be delivered to the patient. The health related information 14 may be derived from information or data gathered by a health monitoring system in step 10 or from personal health related information about the individual in step 12. A health care provider or the individual, in steps 16 and 18, respectively, may take that information and correlate the information with that individual to eventually drive the targeted content. For example, the health care provider or the individual may correlate the information in step 20 with the individual simply by selecting a label or identifier provided by a media content provider to determine future content. This process and decision may also be automated with computer assisted decision support that selects archetype models of characterization and care. If a given individual is a cable customer and has identified or otherwise correlated him or herself in step 20 as desiring content directed at individuals with heart ailments, who have high cholesterol, etc. or just wants content directed at general wellbeing, then the cable or media content provider can send programming to that individual in accordance with that label/s or identification in step 22.

Still further, if a network or content provider has recorded alternative scenes, programming, closed captioned messages and/or advertisements that the network developed for use as targeted content in step 24, the service provider can offer such alternative programming to the individual for display in step 26. The individual may either selectively choose a program, with the targeted content embedded in the program, on a moment by moment basis or may just sign up for all programming and advertisements directed at or complimentary to their health needs. Targeted advertisements may be sent as block of content to the various customers according to their respective labels or identifiers at the appropriate programming intervals.

As shown in FIGS. 3 and 4, the means for delivering media content may comprise, but is not limited to, a stand alone television 30 comprising one or more closed captioning options; or a television 30 and a set top box 38, that is in communication with the television and is adapted to receive analog signals or digital information from an external source 44 such as a cable, cell or satellite service; and a processor 42 that is adapted to receive digital information from an external source corresponding to the targeted content and a digital display device 40 for displaying the targeted content, with or without a local receiver 48. If desired, the means for delivering media content may comprise a display screen adapted to display the targeted content on the screen while simultaneously displaying one or more unrelated images. For example, the target content, such as specific messages 36 or icons, can be delivered by closed captioning or ticker tape style messages scrolling across the bottom section 34 of the display screen while the original image content continues to be displayed over the rest of the display screen 32. The target content may also be embedded into the content being displayed or voiced. The system may be configured to display an icon, to alert the viewer that a message is available for viewing. At which point, the viewer may click on the icon or accessible button to view the targeted message or content. The target content may also be provided wirelessly to a display device 40 via an external source 46, such as a satellite service provider or wireless network. Display device 40 may be an analog or digital television, or desktop or hand held computer, or any other stationary or portable processor, with a suitable display screen (including but not limited to PDAs and IPODs).

The targeted content may comprise any useful individualized information such as one or more advertisements for products or services. The targeted content may further, or alternatively, comprise one or more instructions to take a specific action, such as a health related action. For example, such health related actions may be any number of actions such as but not necessarily limited to, taking one or more medications, modifying lifestyle (e.g., diet or exercise), contacting a health care provider, and turning a device, such as a health related device, on or off. As further examples, other actions may include exercising, ordering or picking up medications or other necessary items, reporting in vital statistics such as blood sugar levels or body temperatures to health care providers, and making or keeping doctor's appointments. Such devices may be, but are not limited to, air purifiers, personal emergency response devices, security systems, hearing aids, oxygen devices, heating and cooling systems, telephones, health monitoring devices, and desk top or hand held computers. The information may also include general suggestions for maintaining and improving health and wellbeing.

The individual's information relating to their states of health may be updated in stock ticker format via the TV or on a computer-based dashboard. A set top box may be used to transmit parameters to the TV from the individual's home computer system or or other suitable devices. The viewing modality may also be generated or ported via a microprocessor-based device such as a computer with an IP addressable input/output. Home health care providers such as nurses and doctors can be given authority to remotely enable closed captioning as a display mechanism and to enter the information, messages or instructions to be displayed by closed captioning.

The individual's health related information may be generated from data gathered through a system that monitors one or more activities of the individual in one or more living areas of the individual. This information may be used to generate at least part of the health related information based on the activity of the individual. The health-related information can be transmitted to health care providers who may, in turn, be responsible for sending the targeted content to the individual. A media content provider, such as a cable, cell or satellite company, may also use health-related information provided by the customer, to label or otherwise identify a particular customer to receive useful, targeted content and advertising.

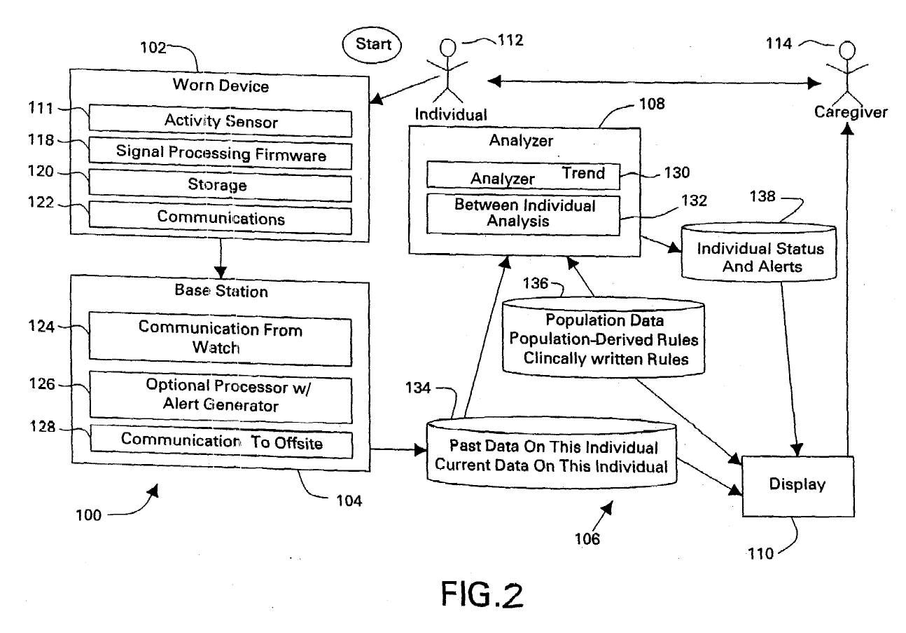

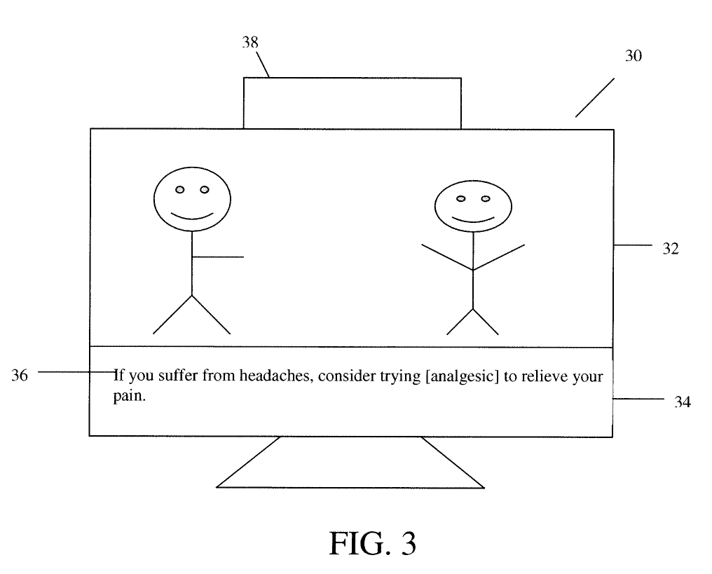

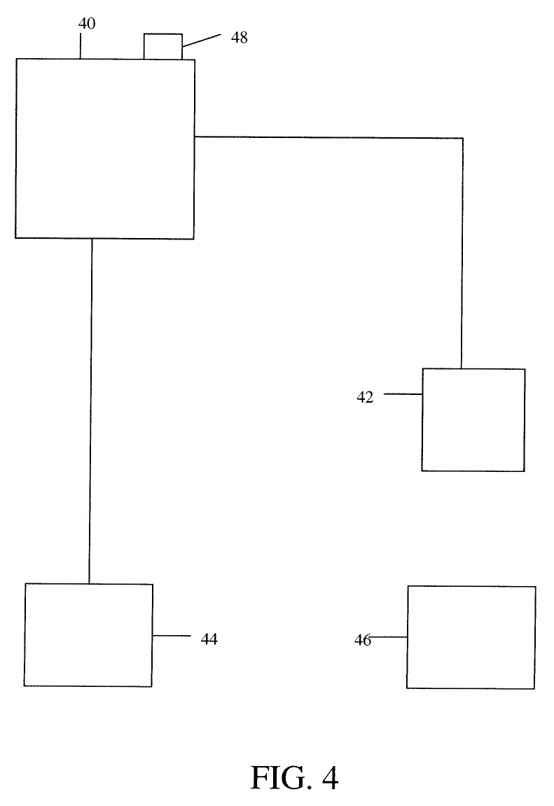

An embodiment of such system for monitoring an individual's activities, physiological measurements, and other personal information, to collect health related information, is shown and generally referred to in FIG. 2 as system 100. System 100 comprises one or more personal devices 102, one or more hubs or base stations 104, one or more local or remote databases 106, and one or more local or remote processors 108. Such remote databases or processors may reside in or otherwise communicate with monitoring center 440. Monitoring center 440 may be configured to be accessible by the individual or authorized caregivers through the Internet or any other suitable wired or wireless means. Device 102 preferably comprises a display 110. Although device 102 is shown in FIG. 2 as a user-wearable, non-encumbering device, device 102 is not limited to a worn device and may comprise any number and type of device suitable for sensing one or more activities (movement, sleeping, opening doors, windows or cabinets, turning on/off devices around home, leaving the living area or home, having visitors, etc.) or physiological indicators (e.g. temperature, pulse, blood pressure, blood glucose levels, weight, etc.) that are relevant to health related information. Device 102 comprises an activity and/or a movement sensor 111 that substantially, continuously monitors and collects the daily-activity data of user 112. Processor 108 may be embodied within device 102, base station 104 and/or a remotely located processing system. The data collected by device 102 may be directly analyzed by processor 108 if housed within device 102 or the data may be transmitted to base station 104 or a remote processor. The data may be transmitted wirelessly or by hardwire.

System 100 may also comprise one or more sensors in addition to the sensor embodied within device 102. A plurality of sensors may be positioned throughout the living area to monitor the individual's more specific activities.

If the processor in the device, base station, or remote monitoring center makes a determination from the daily-activity data of individual 112 that a change in of the activity level of individual 112 has occurred, the processor generates an indication of the change for access by a remote caregiver 114. Medical review may occur within two to three days of receipt of the indication of the change in condition for non-emergency medical attention. The remote caregiver 114 may be presented trends over hours, days and/or weeks to determine what, if any, targeted content messages should be delivered to the individual.

Device 102 allows individual 112 to move about the living area unencumbered while device 102 unobtrusively, automatically and virtually, continuously monitors and collects daily-activity data associated with individual 112. As noted, device 102 may be configured to house a movement sensor 111 and one or more of signal processing firmware 118, storage 120, transmitter 122, a sensor to determine whether the device is being worn or not worn, and/or processor 108. The sensor to determine whether the device is being worn may comprise a temperature sensor and/or magnetic, electrical or light based contact/circuit sensors. Device 102 may be configured to monitor movement, acceleration, vibration, and/or change in orientation. For example, device 102 may comprise one or more of an accelerometer, actigraph, pendulum-based pedometer, tilt switch, vibration sensor, location sensor (e.g. calculates distance traveled), and/or motion detector.

Device 102 is preferably capable of measuring activity levels over twenty-four hour periods for a relatively long-term duration. If desired, device 102 may be configured to measure one or more physiological parameters of individual 112, such as temperature, blood pressure, heart rate and blood sugar, as well.

Device 102 may be housed or otherwise embodied in any convenient, but comfortable, wearable accessory such as, but not limited to, wristbands, wrist or pocket watches, necklaces, pendants and bracelets. Device 102 preferably comprises a data collection means that comprises signal processing firmware 118 and/or storage device 120.

One embodiment of the system for delivering targeted content to specific individuals based at least in part on health related information about an individual generally comprises a communications network that is adapted to deliver the targeted content to the individual through a device for delivering media content. The network may comprise, but is not limited to, a cable network, cellular network, satellite network and/or a computer network.

The targeted content may comprise a variety of information including, but not limited to, advertisements, substantive show content, target messages or instructions, or warnings or alerts.

As an example, patients X, Y and Z may be subscribers of the systems and methods. Patient X has asthma and Patient Y has Class 2 heart failure and Patient Z has Class 4 heart failure. During a televised football game, patient X will receive an Advair® infomercial reviewing proper inhalation techniques and dosing details. A subsequent commercial will review dust free environment practices. Patient Y will get a Carvedilol infomercial that reviews the timing of doses and the importance of dosage adherence. A subsequent commercial will review low sodium diets. Patient Z will get infomercials on the importance of rest and proper diet.

If information is available, for example on Patients X and Y, from a home monitoring system such as system 100, the following two-way communication embodiment may be used. For example, if Patient X has been doing regular peak-flow measurements using a spirometer. As home monitoring readings for Patient X trend downwards, Patient X is alerted via the television. The advertising time block will become focused on the issue and offer recommendations. For example, peak-flow downward trends might render a suggestion to turn on the air purifier, check the air filter and contact a doctor if the condition persists. For patient Y, weight gains would trigger diet and fluid intake reminders, exercise advice and suggestions about contacting health professionals along the path of a protocol that serves as an analytical workflow. The protocol may be broad or specific and supervised by a healthcare provider.

The media content may be configured to be dynamic with respect to the patient's condition. In different, targeted scenes, an actor's condition could specifically mimic patient's issues and address how to best approach it. Content providers would produce these “extra” scenes for people with specific conditions and how they are addressed in the context of the show. The content may have dynamic content either via scene selection or layered visual and/or audio or experiential renderings that correspond to a desired feedback. By the very actions and words embedded in the content, a medical or behavioral feedback is provided. If the protocol for the person viewing the specialized content, based upon that persons biometrical state, should not exert themselves, then the dynamic media is served which has as its scene selection an actor or theme that states what their [as a proxy for the actual patient] biometrical state is and that the acted scene is a decision to reduce activity. The same is true of targeted advertisements. An explicit or implied reading is provided for and an explicit or implied suggestion is offered.

Leveraging the wisdom of crowds, viewers (including, but not limited to, patients, professional and non-professional caregivers) may be encouraged to react to handling of specific conditions and make suggestions about how they feel and other courses of action. This can be implemented via the web or through phone survey software.

Valuation of the dynamic nature of content or tailored advertising relative to actual biometrical feedback and protocol configuration can be made differently than a per viewer fee. Because the viewer can click or scroll through available content and receive a trackable incentive or mearly by dynamic interaction of content coupled to a validation that a targeted demographic watched content, the utility of this delivery modality is dramatically enhanced.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for delivering targeted content to specific individuals comprising the steps of,
providing health related information about one or more of said individuals;
correlating said individual with said targeted content based at least in part on said health related information;
delivering said targeted content to said individual through a means for delivering media content.

2. The method of claim 1, wherein said means for delivering media content is a television comprising one or more closed captioning options.

3. The method of claim 1, wherein said means for delivering media content is a television and a set top box, that is in communication with said television, adapted to receive signals from an external source.

4. The method of claim 1, wherein said means for delivering media content is a processor that is adapted to receive digital information from an external source corresponding to said targeted content and a digital display device for displaying said targeted content.

5. The method of claim 1, wherein said means for delivering media content comprises a display screen adapted to display said targeted content on said screen while simultaneously displaying one or more unrelated images.

6. The method of claim 1, further comprising the steps of monitoring the activity of said individual in a living area of said individual and generating at least part of said health related information based on said activity of said individual.

7. The method of claim 1, wherein said targeted content comprise one or more advertisements for products or services.

8. The method of claim 1, wherein said targeted content comprises one or more instructions to take one or more specific actions.

9. The method of claim 8, wherein said actions are health related.

10. The method of claim 9, wherein said health related actions are selected from a group of actions consisting of: taking one or more medications, contacting a health care provider, and turning a health related device on or off.

11. A system for delivering targeted content to specific individuals based at least in part on health related information about an individual comprising, a communications network that is adapted to deliver said targeted content to said individual through a device for delivering media content.

12. The system of claim 11, wherein said device for delivering media content comprises a television comprising one or more closed captioning options.

13. The system of claim 11, wherein said device for delivering media content is a television and a set top box, that is in communication with said television, adapted to receive signals from an external source.

14. The system of claim 11, wherein said device for delivering media content is a processor that is adapted to receive digital information from an external source corresponding to said targeted content and a digital display device for displaying said targeted content.

15. The system of claim 11, wherein said device for delivering media content comprises a display screen adapted to display said targeted content on said screen while simultaneously displaying one or more unrelated images.

16. The system of claim 11, wherein said network comprises a cable network.

17. The system of claim 11, wherein said network comprises a satellite network.

18. The system of claim 11, wherein said network comprises a computer network.

19. The system of claim 11, wherein said network comprises a cellular infrastructure.

20. The system of claim 11, further comprising an activity monitoring system for monitoring the activity of said individual in a living area of said individual and generating at least part of said health related information based on said activity of said individual.

21. The system of claim 11, wherein said targeted content comprises one or more advertisements for products or services.

22. The system of claim 11, wherein said targeted content comprise one or more instructions to take one or more specific actions.

23. The system of claim 22, wherein said actions are selected from a group of actions consisting of: taking one or more medications, contacting a health care provider, and turning a device on or off.

24. The system of claim 11, wherein said targeted content is selectively promulgated from a plurality of predetermined scenarios.
